(19) United States
(12) Patent Application Publication
(10) Pub. No.: US 2018/0141738 A1
(43) Pub. Date: May 24, 2018

(54) CONTAINMENT SYSTEM

(71) Applicants: Joseph Armano, North Andover, MA (US); Frank Wilker, San Francisco, CA (US); Josh Hizon, San Francisco, CA (US); Seth Zimring, San Francisco, CA (US)

(72) Inventors: Joseph Armano, North Andover, MA (US); Frank Wilker, San Francisco, CA (US); Josh Hizon, San Francisco, CA (US); Seth Zimring, San Francisco, CA (US)

(73) Assignee: Cromulent Solutions, Inc., Oakland, CA (US)

(21) Appl. No.: 15/821,756

(22) Filed: Nov. 22, 2017

Related U.S. Application Data
(60) Provisional application No. 62/425,074, filed on Nov. 22, 2016.

(51) Int. Cl. B65D 81/26; B65D 85/30; B65D 85/50; B65D 45/02; B65D 90/48; G08C 19/00

(52) U.S. Cl. CPC B65D 81/266; B65D 85/30; B65D 85/50; B65D 2590/0083; B65D 90/48; G08C 19/00; B65D 45/02

(57) ABSTRACT

A product containment system is provided and includes an open bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin, at least one pressure valve incorporated into the bin lid or into the at least one bin side wall and optionally one or more telemetric devices incorporated or otherwise disposed within the bin volume and or on the external surfaces of the bin, the telemetric devices adapted to record and retain data for access by a remote computing appliance.

### CROSS-REFERENCE TO RELATED DOCUMENTS

The present application claims priority to a U.S. provisional patent application Ser. No. 62/425,074 entitled CONTAINMENT SYSTEM, and filed on Nov. 22, 2017, disclosure of which is incorporated herein by reference.

### BACKGROUND

### 1. Field of the Invention

The present invention relates to the field of shipping containers for organic materials and pertains particularly to a containment system and apparatus for short-term storage, long-term storage, transport, and process monitoring of perishable goods. More specifically, a storage bin that can be used to store and/or transport and/or process, and/or monitor, and/or cure fruits, vegetables, grains, produce, tobacco, hops, coffee, teas, spices, paper, art, clothing, hemp, marijuana, cannabis in the form of flowers (dried or damp), plants, plant tissue, flour, butters, oils, seeds, kief, extracts, or any other contemplated or known cannabis product, processed or unprocessed, any other perishable goods, or any other organic or inorganic material subject to breakdown by light, oxidation, mold/fungus, bacteria, heat, or damage during storage or transportation due to crushing.

### 2. Discussion of the State of the Art

Perishable goods, such as produce, crops, seeds, spices, paper, art, clothing and other organic materials, as well as inorganic materials, are subject to breakdown often stored by light, oxidation, mold/fungus, bacteria, heat, or animals or damage during storage or transportation due to crushing. Storage and transportation devices and conditions can be used to prevent or retard the breakdown of these goods.

Perishable goods, such as produce and crops, are often stored and transported in large crates or wax-covered boxes open to the air. Other goods are packaged in sealed airtight metal cans or bags to promote freshness. Such packaging can help slow the breakdown of stored goods by limiting the availability of oxygen (O₂) or carbon dioxide (CO₂), reducing oxidation, inhibiting growth of some types of mold and fungus, moisture loss, and other types of spoilage. Further, there are smart packaging examples where the packaging includes sensors for monitoring the interior of a package and may display results such as temperature, humidity level, oxygen levels, or carbon dioxide levels.

Some packaging has a controlled atmosphere that is sterile and oxygen-free to inhibit the growth of aerobic bacteria and reduce oxidation reactions. Different processes exist to lower the amount of oxygen (O₂) from the naturally occurring amount of 20.9% to less than 0.1%. Techniques known to the inventor are gas-flushing, oxygen scavenging, and compensated vacuum packing and are commonly used to pack perishable goods. In gas-flushing, the desired gas mixture is instilled into the packaging, pushing out the air. The compensated vacuum technique removes the air and then instills the desired gas mixture. Alternatively, packets or sachets containing oxygen scavengers or oxygen absorbers may be added to sealed containers to remove oxygen. Many types of oxygen scavengers covering a wide array of applications are available.

Goods can be are often packaged utilizing Modified Atmosphere Packaging (MAP) which allows chemical, enzymatic or microbiological reactions to be controlled, reducing or eliminating the main processes that lead to degradation. MAP changes the composition of the gases inside of packaging to prevent breakdown of the goods. Commonly with MAP, the internal atmosphere of a package is either replaced or modified to reduce or eliminate oxygen (O₂) and replace it with nitrogen (N₂). Nitrogen (N₂) is inert at the temperatures and pressures to which the packaging is typically subjected. An oxygen-free internal atmosphere inhibits the growth of aerobic bacteria and stops oxidation reactions which can damage the goods.

Some packaging may control temperature within using insulation or by other means. For instance, a cold chain is a temperature-controlled supply chain. An unbroken cold chain is an uninterrupted series of storage and distribution activities which maintain a given temperature range. It is used to extend and ensure the shelf life of products such as fresh produce, other foods, chemicals, and pharmaceutical drugs.

Some perishable goods are shipped with low-gas permeability films (sometimes called high barrier films). Conversely, fruits and vegetables are respiring products whose interaction with the packaging material is important and thus, high permeability, or low barrier, films are used. If the carbon dioxide and oxygen permeability of the packaging film is adapted to the products level of respiration, an equilibrium-modified atmosphere may be established in the package, and the shelf life of the product may be increased.

Some goods are packaged with smart or intelligent packaging that monitors the interior of the package, displaying, for instance, temperature, humidity level, oxygen levels, or carbon dioxide levels. Smart or intelligent packaging can include the ability to control temperature and air content such as levels of oxygen, carbon dioxide, or humidity inside a package. Additionally, this technology can include the ability to sense or measure an attribute of the interior atmosphere of the package or the shipping atmosphere. This information can be communicated to users or can trigger active packaging functions. Furthermore, some types of packaging are integrated with microelectronics, computer applications, or nanotechnology.

Curing is a method of drying hops, tobacco, teas, herbs, cannabis or any other crops over days or weeks. Crops can be cured in a sealed container, by replacing air from the inside of the container with fresh air in a process called “burping”. Curing attempts to achieve a uniform moisture content throughout the entire cluster crop from stem or stalk to flowers or leaves, and removes chlorophyll from the plant. Although it is possible to cure a crop in a container, it is not achieved easily. Often crops are hampered by mold or other pathogens, or the moisture content is not uniform. In this evolving field, packaging, particularly that used for Modified Atmosphere Packaging (MAP), is limited often to containers that are sealed in a manner such that they can only be opened once. Such packaging tends to be limited in size and geared towards the consumer level, as opposed to targeting the wholesale level.

Therefore, what is clearly needed is a containment system and apparatus including bins that may be used to cure crops in transit, opened and sealed more than once during shipping and scaled to accommodate larger wholesale produce quantities.

### BRIEF SUMMARY

This application describes a product containment system is provided and includes an open bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin, at least one pressure equalization valve incorporated into the bin lid or into the at least one bin side wall, at least one flush valve incorporated into the bin lid or into the at least one bin side wall, and optionally one or more telemetric devices incorporated or otherwise disposed within the bin volume and or on the external surfaces of the bin, the telemetric devices adapted to record and retain data for access by a remote computing appliance.

In one embodiment, a containment system is provided and includes an open bin having a closed end, at least one side wall, and an open end bordered by a substantially horizontal sealing surface and an internal volume defined by the enclosure below the sealing surface; a bin lid configured geometrically to fit over the bin, a gasket disposed between the bin lid and the sealing surface of the bin; at least one valve, wherein the at least one valve is any valve necessitated by design and optionally comprises an equalization valve, ball valve, quarter-turn valve, check valve, gate valve, or pressure-reducing valve or other types of valves; and optionally, one or more telemetric devices incorporated or otherwise disposed within the bin volume and or on the external surfaces of the bin, the telemetric devices adapted to record and retain data for access by a remote computing appliance.

In another embodiment, a containment system is provided and includes an open bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin, at least one pressure equalization valve incorporated into the bin lid or into the at least one bin side wall, at least one flush valve incorporated into the bin lid or into the at least one bin side wall.

In a preferred embodiment, the bin is square and includes four bin side walls. In another embodiment, the bin is annular and has a single cylindrical or elliptical side wall. In yet another embodiment, the product containment system further includes a plurality of latch clamps affixed to and strategically disposed about the exterior surface or surfaces of the bin, the latch portion of each clamp latching onto an upwardly hooked lip extending contiguously or in linear distances about the peripheral edge of the lid. In an alternative embodiment, the product containment system further includes at least one turn knob clamp and a centrally mounted internal rod interface adapted to seat the turn knob through a central opening provided in the bin lid, the turn knob including a gasket disposed between the knob and the bin lid surface.

In one embodiment, the horizontal sealing surface is the top surface of a bin flange extending around the top edge or edges of the bin. In an alternative embodiment, the horizontal sealing surface is a top surface of a bin sleeve fixed to the top outer edge or edges of the bin. In one embodiment, the bin lid comprises a compression frame and a bin lid sheet. In one embodiment, the bin lid is drawn down in manufacturing thereby producing a lid primary surface that resides at a lower horizontal plane than the bin lid edges.

In one embodiment, the product containment system further includes multiple brackets disposed about the external top surface of the bin, the brackets abutting against the under surface of the flange, thereby reinforcing the rigidity of the bin flange. In one embodiment, the bin further includes a connector plug adapted to bridge a data link between the one or more telemetric devices and a remote computing appliance.

In one embodiment, the one or more telemetric devices is incorporated into the structure of the bin and includes a display device incorporated into the bin or the bin lid, the display device adapted to be manipulated by a user to access readings produced by collecting and processing data from sensors deployed within the volume of the bin. In one embodiment, the latch clamps are lockable via a key, a combination, or a wireless code. In one embodiment, the bin lid contains a pop up bubble feature that pops down when a vacuum pressure of a certain threshold is applied within the bin.

In one aspect, a method is provided for aggregating, containing, and preparing organic product for shipping comprising steps (a) position a product containment system bin for loading product, the bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin, at least one valve incorporated into the bin lid or into the at least one bin side wall, wherein the at least one valve is any valve necessitated by design and optionally comprises an equalization valve, ball valve, quarter-turn valve, check valve, gate valve, or pressure-reducing valve or other types of valves; and optionally one or more telemetric devices incorporated or otherwise disposed within the bin volume, (b) if specified, place one or more product treatment items and or disperse one or more product treatment substances into the bin, (c) load or otherwise disperse organic product into the bin volume to a level deemed appropriate for shipping or storage, (d) position the bin lid over the bin sealing surface and clamp the bin lid down over the gasket and sealing surface of the bin, (e) if specified, connect a vacuum pump by vacuum hose and fitting to the flush valve on the bin and pump the atmosphere out of the bin to a specified vacuum pressure, (f) disconnect and seal the flush valve once specified vacuum pressure is realized, and (g) arrange bin for shipping or storage.

In one aspect of the method, in step (b), the one or more product treatment items include one or more oxygen absorbers and or one or more humidity control packets. In a variation of this aspect of the method, in step (b), the one or more product treatment substances include one or a combination of terpenes, mold inhibitors, parasite inhibitors.

In another aspect of the method for acquiring data recorded by one or more telemetric devices incorporated by physical placement or original equipment manufacturer (OEM) into a product containment system having an open bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin comprising steps (a) connect a remote computing appliance running a software application by data cable or by a wireless data link to a bridge connector hermetically sealed into the bin wall or bin lid, (b) through the software application, access one or more categories of bin data recorded and stored for access, (c) upload some or all of the available data onto the remote computing appliance, and (d) terminate the connection formed at step (a).

It is understood that any embodiment descried herein may record, store, download, or upload data to remote storage, such as a private server, or the cloud.

In one aspect of the method, in step (a), the bridge connector is one of a universal serial bus (USB) cable connector or a wireless transceiver node. In one aspect of the method, in step (b) the data categories may include but are not limited to product and or bin related data such as relative humidity, barometric pressure, temperature, product content humidity, mold or other contaminant level, presence of parasitic involvement, product potency state, oxygen levels, and gas levels, and or electronic shipping data such as estimated arrival times, dock wait times, location data, bar code data, and RFID chip data.

### BRIEF DESCRIPTION OF THE DRAWINGS

FIG. 1 is a perspective view of an embodiment of a containment system.

FIG. 2 is a side elevation view of a bin.

FIG. 3 is a sectioned view of the bin of FIG. 2 taken along the sectioning lines A-A.

FIG. 4 is an exploded view of components of the containment system taken from detail B of FIG. 3.

FIG. 5 is a perspective assembly view of components of the equalization valve of FIG. 1.

FIG. 6 is a perspective view of the pressure equalization valve of FIG. 5.

FIG. 7 is an elevation view of the pressure equalization valve of FIG. 5 assembled depicting section line A-A.

FIG. 8 is a sectioned view of the pressure equalization valve of FIG. 7.

FIG. 9 is a perspective view of the flange support bracket of FIG. 4.

FIG. 10 is a perspective view of the bin of FIG. 1 with the bin lid brackets and locks removed to expose the bin flange.

FIG. 11 is an elevation view of the bin of FIG. 1 with section lines A-A to depict a step profile of the bin flange.

FIG. 12 is a section view of the bin of FIG. 1 taken along the lines A-A of FIG. 11.

FIG. 13 is an exploded view of detail B of FIG. 12 depicting a step profile geometry to add rigidity support to the overall flange.

FIG. 14 is a perspective view of another embodiment of containment system.

FIG. 15 is an elevation view of the bin of FIG. 14 with section lines A-A.

FIG. 16 is a section view of the bin of FIG. 15 taken along section lines A-A.

FIG. 17 is an exploded view of the rod and turn knob interface for locking down the bin lid and achieving a seal.

FIG. 18 is a perspective view of the bin of FIG. 14 depicting the bin lid and turn knob installed without a slip shield and a lock.

FIG. 19 is an overhead view of the square bin of FIG. 1 with section line A-A depicting a bin lid.

FIG. 20 is a section view of lid 2 taken along section line A-A of FIG. 19.

FIG. 21 is an exploded view of detail B of FIG. 20.

FIG. 22 is a block diagram in perspective view depicting a sensor-loaded circuit board that may be installed within the internal space of a containment bin.

FIG. 23 is a perspective view of an embodiment of containment system.

FIG. 24 is a perspective view of an embodiment of bin sleeve 51.

FIG. 25 is a section view of bin sleeve 51 of FIG. 24 taken along a center line.

FIG. 26 is a perspective view of an oxygen absorbing pack or packet 55 used to reduce the amount of oxygen in a containment system bin.

FIG. 27 is an overhead view of a bin lid having a different edge design than bin lid 2 of FIG. 19.

FIG. 28 is a perspective view of the lid of FIG. 27.

FIG. 29 is a section view of the lid of FIG. 27 taken along section lines A-A.

FIG. 30 is an exploded view of detail B of FIG. 29.

FIG. 31 is an overhead view of a bin lid having a raised surface profile instead of a recessed surface profile edge design like lid 2.

FIG. 32 is a perspective view of the bin lid of FIG. 31 depicting a raised lid surface.

FIG. 33 is a section view of the lid of FIG. 32.

FIG. 34 is an exploded view of detail B of FIG. 33.

FIG. 35 is a perspective view of an embodiment of a bin lid having a central draw.

FIG. 36 is a section view of the lid of FIG. 35.

FIG. 37 is a process flow chart 70 depicting steps for loading a containment system to ship according to an embodiment of the present invention.

FIG. 38 is a process flow chart 81 depicting steps for applying vacuum to a specified pressure.

FIG. 39 is a process flow chart 90 depicting steps for accessing state data from a telemetric system native to a containment system.

### DETAILED DESCRIPTION OF THE DRAWINGS

This application provides a unique containment system for storing perishable items. The present invention is described using the following examples, which may describe more than one relevant embodiment falling within the scope of the invention.

In various embodiments described in enabling detail herein, the inventors provide a unique containment system used for short-term storage, long-term storage, transport, and process monitoring of fruits, vegetables, grains, produce, tobacco, coffee, teas, hops, spices, paper, art, clothing, hemp, marijuana, cannabis in the form of flowers (dried or damp), plants, plant tissue, flour, butters, oils, seeds, kief, extracts, or any other contemplated or known cannabis product, processed or unprocessed, or any other perishable goods, or any other organic or inorganic material subject to breakdown by light, oxidation, mold/fungus, bacteria, heat, or damage during storage or transportation due to crushing. The system includes a unique bin, container, canister, receptacle, box, carton, or crate, having a removable lid that can be affixed to said bin, container, canister, receptacle, box, carton, or crate, that can create an airtight, or hermetic seal. The present application describes embodiments of the system using the following examples, which may describe more than one relevant embodiment falling within the scope of the invention.

In this application, “hermetic seal” or “hermetically sealed” shall refer to a seal that is airtight or substantially airtight. “Airtight” shall mean that no liquid, air, moisture or gaseous molecules escape or pass through a seal into or out of a container. “Substantially airtight” shall mean that unintentional liquid, air, moisture or gas exchange is limited such that the internal atmosphere is maintained within 5% of its intended composition, or in other words, each type of liquid or gas only increases or decreases such that the percentage of the overall composition of each liquid or gas in a container increases or decreases by less than 5% over a period of 1 year.

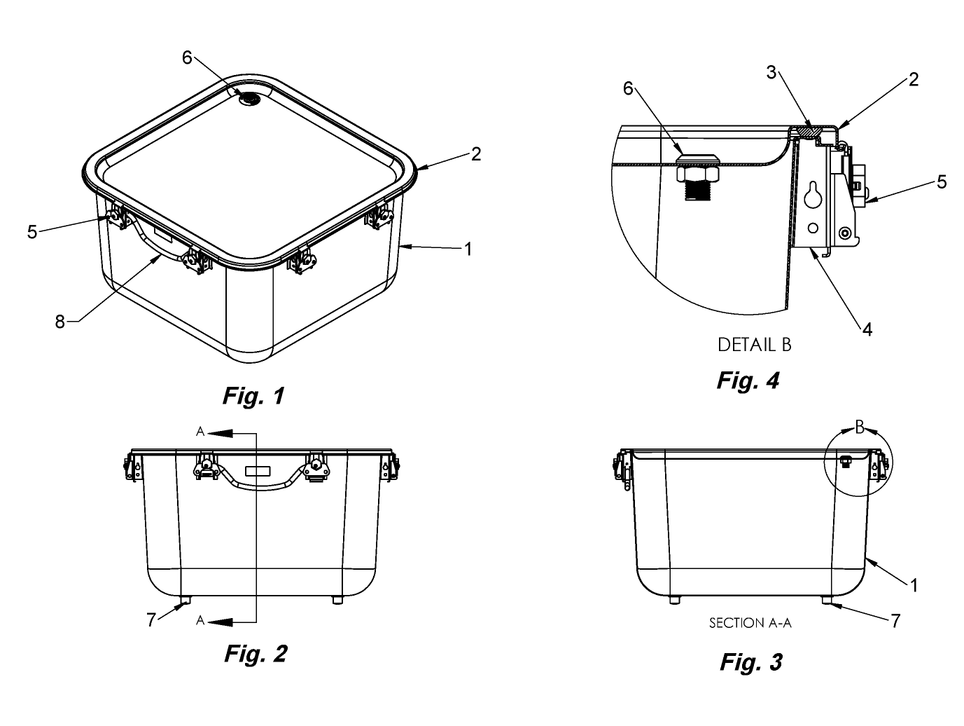

FIG. 1 is a perspective view of a containment system. The containment system includes a bin 1 that may be referred to in some embodiments as a container, canister, receptacle, box, carton, or crate. For the purposes of discussion, the term bin is used throughout this specification. Bin 1 may be a deep drawn stainless-steel bin, or a stainless-steel bin welded from sheet metal parts without departing from the spirit and scope of the present invention. In any embodiment described herein, the bin may be comprised of a rigid or semi-rigid material. The rigid or semi-rigid material may include stainless steel, reinforced stainless steel, steel, aluminum, reinforced aluminum, any other metal, metal alloy, plastic, or any combinations thereof. The bin is, in a preferred embodiment, comprised of stainless steel or reinforced stainless steel.

Bin 1 is geometrically rectangular and is square in this example having four walls of equal length and height. However, that is not a requirement to practice the invention as bin 1 may be provided in a variety of other geometric shapes. In any embodiment described herein, the bin shape may be substantially cubical, rectangular, hexagonal, prism, conical, cylindrical, frustuminal, or any other three-dimensional shape without departing from the spirit and scope of the present invention. Bin 1 has rounded or otherwise smoothed corners and edges in this example, but may also include one or more sharp edges or corners as may be dictated by design.

Bin 1 has a wall thickness and a floor or bottom wall thickness substantially sufficient to withstand bulging due to gas buildup or internal collapse under vacuum pressure relative to the volume capacity of the bin. Bin 1 is adapted with an open top and a flange or top surface for accepting a lid 2 having a channel or furrow for a lid gasket. The top lip or flange portion of bin 1 may be reinforced or otherwise stiffened by hardening or other material straightening fabrication methods.

Lid 2 is adapted to fit over the lipped or flanged portion of bin 1 and to seal against the flange surface using a gasket to create a hermetic seal. Lid 2 may be a deep drawn stainless-steel lid conforming to the geometric shape of the top of bin 1. Lid 2 may in one embodiment be welded from two or more parts. Lid 2 may also be comprised of any rigid or semi-rigid metal or material, and preferably said rigid or semi-rigid material, is non-permeable to oxygen, other gases, or water. Lid 2 has a thickness sufficient to enable stacking of multiple bins like bin 1 without deformation and/or is substantially sufficient to withstand bulging due to gas buildup or internal collapse under vacuum pressure relative to the volume capacity of the bin. Lid 2 is recessed toward the interior surface of the lid to provide for a strong surface across the opening of bin 1.

Lid 2 is adapted to be clamped or latched down to the top of bin 1 using a plurality of latches 5. In this example, there are eight latches 5 (or two latches 5 per bin side) to accomplish even force and pressure across the seal between the lid and bin. Lid 2 has a formed peripheral edge designed to enable latching. Latches 5 may be enabled for locking. In one embodiment lid 2 comprises two separate components namely a lid sheet and a latch flange latched in place over the lid sheet wherein the lid sheet abuts against the gasket, the gasket set into a groove provided in the top portion of the bin flange. In this implementation, lid 2 is a contiguous deep drawn stainless-steel or metal part.

Lid 2 includes an opening provided there for accepting installation of a bin valve 6. Valve 6 enables a user to release pressure built up within the bin or to remove or relax vacuum within the bin to enable unlatching and removal of the lid. Valve 6 is hermetically sealed to the lid wall, lid sheet, bin wall or any exterior surface of the sealed interior. Valve 6 may also be referred to herein as an equalizer valve. Valve 6 may be any type of known pressure release valve. In one embodiment, the pressure relief valve is a spring-loaded (mechanical or gas) valve, which will release pressure or break vacuum within bin 1. In this implementation the inventor provides a valve construction known to the inventor that is advantageous to embodiments of the invention. More detail relative to an embodiment of valve 6 is provided later in this specification. In other embodiments, the valve may be any valve necessitated by design, including but not limited to an equalization valve, ball valve, quarter-turn valve, check valve, gate valve, or pressure-reducing valve or other types of valve.

Bin 1 may include one or more than one handle apparatus such as handle 8 for moving and lifting bin 1. Handle 8 may be a rope or fabric handle, or a handle fabricated of another material such as rubber, polymer, chain, steel, aluminum, or any other similar sturdy material. Bin 1 may be manufactured with any volume and dimension. In one application, the bin may be manufactured to a 15 to 25-gallon volume. Bin 1 may be a nominal 20-gallon bin, for example. Although bin 1 may be fabricated to hold smaller amounts by volume, in a preferred implementation, bin 1 may contain up to 20 pounds of dried materials, fruit, produce, or any other perishable good or material described herein. Bin 1 may be larger (commercial scale) or smaller (consumer scale) without departing from the spirit and scope of the present invention.

In one embodiment, the interior of the containment system may include one or more separators to subdivide the product being stored such that different products are compartmentalized within the bin. Separators or partitions may be built into the bin, affixed to the bin, or removably attached to the bin. The separators or partitions may be fabricated of stainless steel, other metal, or other rigid, semi-rigid or flexible materials. The separators or partitions may be disposed substantially vertically or horizontally relative to the bottom floor of the bin. For example, five pounds of dry plant material might be stored on the bottom floor of the bin wherein a horizontal separator may then be installed or attached to the inside of the bin above the first layer of product. A next five-pound layer of product might be distributed over the top of the separator or partition, and so on. It may be apparent to one with skill in the art of packing that air packets, fillers, packing popcorn, bubble wrap or other materials including potential separator or partition parts might be used within a containment system to prevent an organic product from becoming squished, deformed, or compacted during transit or long-term storage.

FIG. 2 is a side elevation view of bin 1. In this example, bin 1 includes bin feet 7, typically four bin feet 7 concurring with the square shape of the bin. Bin feet 7 may be rubber, polymer or made of other durable but non-hardened materials that might damage other bins during stacking. Bin feet 7 may be annular feet or they may be provided in other shapes. In a preferred embodiment, bin feet 7 are symmetrically positioned inward from the edge of the bin so as not to interfere with the lids in stacking. In one implementation no feet such as bin feet 7 are provided and bins rest on their floor surfaces.

FIG. 3 is a sectioned view of bin 1 of FIG. 2 taken along the sectioning lines A-A. In this view of bin 1, equalization valve 6 is visible both above and below the wall of the lid. In this view, the thickness of the bin walls and lid wall is not readily visible due to resolution limitations in reproduction of the drawings. Therefore, the inventor highlights a portion of the sectioned view for exploded detail in FIG. 4.

FIG. 4 is an exploded view of components of the containment system taken from area B of FIG. 3. Detail B depicts the upper right corner area of bin 1 in section A-A of FIG. 3. Equalization valve 6 is installed through an opening provided for the purpose in the wall of lid 2. Valve 6 may be depressed in one embodiment to equalize pressure between the external and internal space relative to bin 1. Lid 2 as described further above may be a deep drawn stainless-steel lid. In this example, lid 2 is deep drawn resulting in the wall of the lid residing below the top surface of bin 1 and leaving a peripheral radius leading up to a top plane of flat surface of lid 2 that extends over the top edge (flange top surface) of bin 1.

A gasket 3, which may be an O-ring type gasket is provided and herein depicted resting in place between the top flange surface of bin 1 and the underside of the top flat surface of lid 2. Gasket 3 may be custom formed to fit a groove design in the top flange of bin 1. Gasket 3 is preferably manufactured from Nitrile, Butyl, any other FDA approved material, or any other suitable material. Gasket 3 may be of any shape, including, but not limited to, square, elliptical, circular, rectangular, semi-circular, semi-elliptical or any other shape as dictated by design. The O-ring/gasket may be substantially flat or rounded, as the design dictates.

In this implementation, gasket 3 sets into a groove provided in the top surface of a flange at the top of bin 1. Lid 2 extends to and over the outer edge of the bin flange and down the exterior thereof to a latch lip flange or latch flange. The latch flange extends all around the perimeter of lid 2 and are raised up slightly to enable latches 5 to latch onto the edge of lid 2. In one embodiment, the hooked or raised edge may be provided just at the locations of latches 5 and is not required all around the lid.

A plurality of flange and latch support brackets 4 are provided and co-located one on either side of a latch 5. Brackets 4 may be manufactured of stainless steel, aluminum, or other metals or rigid materials. In the event of eight latches disposed two each on each side of bin 1, there would be eight flange brackets 4 to support the bin flange and further to provide a latch mounting location at the correct vertical plane beneath the lid lock latch edge for proper function. Flange support brackets 4 provide additional structural support for the bin flange guarding against collapse or deformity. It is noted herein that the side profile of the in flange is a step down from a top under surface supported by the top surface of brackets 4 to a stepped down under surface that is also supported by the bracketed step-down feature. Brackets 4 may also provide tether openings for wiring or locking multiple bins together, or to a vehicle, in shipment to prevent sliding, inadvertent movement, and/or mounting points for handles such as handle 8 of FIG. 1.

In this embodiment, bin 1 is flanged wherein the flange includes a groove for seating an O-ring type gasket and the lid is deep drawn and includes an overhanging perimeter edge for latching down the lid using bracket mounted latches 5, such as that can be operated by lever or other mechanics to lock lid 2 down over bin 1 mitigated by gasket 3 to form a hermetic seal. In other embodiments, there may be other bin and lid designs that may accomplish the same goal of protecting the contents within the bin regardless of vacuum state or pressure state within the bin without departing from the spirit and scope of the present invention.

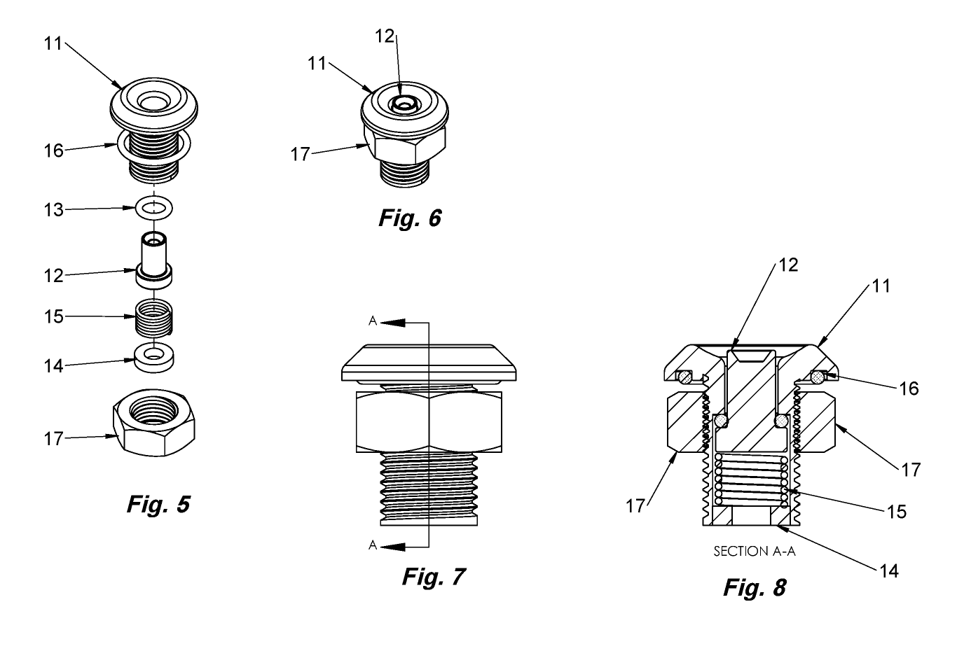

FIG. 5 is a perspective assembly view of components of equalization valve 6 of FIG. 1. The equalization valve is a spring-loaded valve that a user may depress a pin to release pressure or to release vacuum relative to the internal volume of bin 1. The valve is designed to be low in profile above the surface of the lid wall so as not to interfere with bin stacking. The valve includes a valve body 11, which may be a stainless-steel (or metal or other rigid material) component machined or otherwise fabricated to include a stem portion and head portion. Valve body 11 is hollow to the extent that it has a vertical opening there through to enable air to pass. Valve body 11 includes an annular head portion and a cylindrical stem portion that is externally threaded to accept a hex head nut to secure the valve to the lid of the bin. The under surface of the head portion of valve body 11 may be grooved to accept an O-ring gasket 16. Gasket 16 is preferably made of Nitrile, Butyl, any other FDA approved gasket material, or any other suitable material.

The inside diameter of valve body 11 is just large enough to accept a valve pin 12 into the stem portion of valve body 11. Valve pin 12 may be a stainless-steel component machined or otherwise fabricated to include a stem portion and a head portion or flange. Valve pin 12 includes an interfacing surface or flange that may serve as a seat surface for an O-ring gasket 13. Gasket 13 is preferably a Nitrile or Butyl gasket, or a gasket made from any other FDA approved material or any other suitable material. The opposite or upper side of gasket 13 is held against a gasket interface surface or shelf inside the stem portion of valve body 11 such as one fabricated by counter boring into the stem to a strategic depth.

Valve pin 12 is held against the valve body by spring force using a coil spring 15. A closing plug 14 is provided to be press fit into the stem opening to close the valve and keep the pin and spring engaged against the valve body and gaskets to create a hermetic seal able to withstand normal vacuum or pressure conditions within the bin, and may optionally be capable of opening automatically when vacuum levels inside the bin exceed a certain predetermined level.

FIG. 6 is a perspective view of the pressure equalization valve of FIG. 5. In this view nut 17 is threaded up to position with O-ring gasket 16 providing the main seal against the top surface of the bin lid. Nut 17 is tightened against and abuts against the bottom surface of the bin lid or other external surface. In one embodiment, valve body 11 (FIG. 5) is configured with a hex facet pattern for accepting a tool, such as a wrench to sterilize the body (keep it from rotating) while it is fastened to the lid.

Valve pin 12, more particularly the top edge thereof protrudes just above the chamfer (counter sink) disposed around the central passage through the valve body. In this design a user may push down against spring force to breach the seal and allow pressure to equalize. In one embodiment, a pressure gauge may be added to the assembly to inform a user of state of pressure buildup within the bin or the state of vacuum within the bin. In other embodiments, various attachments may be provided, and utilized, to operate the valve such as a quick connect adapter for connecting a vacuum hose or gas hose, for example. Alternatively, in other embodiments, there may optionally be no pressure indicating attachments.

FIG. 7 is an elevation view of the pressure equalization valve of FIG. 5 assembled depicting section line A-A. FIG. 8 is a sectioned view of the pressure equalization valve of FIG. 7. Referring now to FIG. 8, close plug 14 is pressed into the opening in the stem portion of valve body 11 keeping compressed coil spring 15 against valve pin 12, which is duly compressed against O-ring gasket 13 and a seal interface provided within the valve body 11. The top of the valve pin 12 extends above the bottom of the chamfer around the valve passage, but remains below the top surface of valve body 11, which may prevent accidental operation.

Coil spring 15 provides enough range of compression to enable further compression by urging the valve pin down against the spring to break the valve seal at O-ring 13. Nut 17 abuts against the bottom surface of the bin lid while O-ring 16 sits in a groove placed in the under surface of the head portion of the valve body and abuts against the top surface of the bin lid. While other valves having differing mechanics such as a lever-operated ball valve mechanism might be used as a pressure relief or equalization valve, the inventor provides valve 6 with a low-profile design adapted to reduce possibility of unintended actuation of the valve and to facilitate bin stacking without interference of the valve structure.

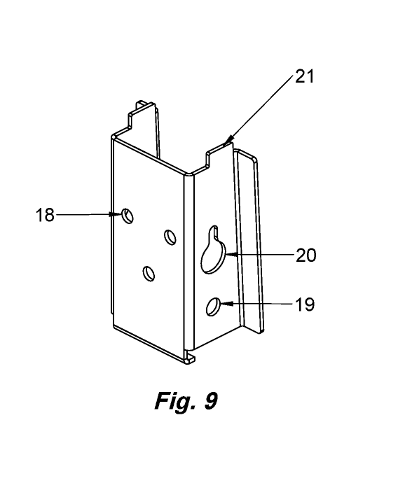

FIG. 9 is a perspective view of flange support bracket 4 of FIG. 4. Bracket 4 may be manufactured of stainless steel, aluminum, or other rigid or semi-rigid materials. The bracket serves two main functions. Firstly, brackets 4 are fixed to the bin by welding or by other methods at a position such that the plurality of brackets for a bin provide structural rigidity support to the bin flange. The bracket may be a formed or stamped part or a machined part. The bracket is formed as a three-sided rectangle having two opposing parallel sides and a conjoining back plate or wall perpendicular to the sides of the bracket.

Bracket 4 has opposing wing flanges disposed at the open edges of the bracket sides by sheet metal stamping or form bending. The wing flanges extend outward and perpendicular to the bracket sides and provide a seating surface against the side wall of the bin for welding the bracket, or otherwise fixing the bracket to the bin wall. Bracket 4 has a top surface 21 exhibited at both sides of the bracket that provides rigid support for the bin flange. Bracket 4 abuts against the under surface of the bin flange.

Bracket 4 includes a plurality of through openings 18 strategically located in the conjoining back plate. Openings 18 may serve as mounting points for mounting a latch such as latch 5 of FIG. 4. The depth of bracket 4 is such that the position of a mounted latch is ideal for securing the bin lid down over and against the bin flange and gasket. Bracket 4 includes a through opening 19, one each, disposed through each side wall of the bracket. Opening 19 may be sufficiently large to accept a wire, other rope or strap that may be threaded through the outside brackets of a group of bins gathered or stacked together in one area such as while in transit shipping so that the bins may be tied together and perhaps also tied down to a wall or surface to prevent shifting.

In one implementation, the containment systems may be connected and or locked together, and/or to other surfaces, using temporary releasable fasteners, straps or other hardware. The containment systems may optionally be physically connectable side-by-side by one or more physical features, such that they could be easily moved between pallets. Two or more containment systems may be connected to one another vertically (stacked), side-by-side (adjacent). Bracket 4 includes an opening 20 placed through each of the side walls of bracket 4. Opening 20 is in the form of a key-hole shape for accepting installation of the end of a handle (handle not illustrated) such as handle 8 of FIG. 1.

In one implementation, each bin may include at least four physical standoffs, typically at least one on each bin side that extend past the distance from the bin wall to the outer edge of the lock mounted on the bracket. Such standoff features may include permanently installed or removable blocks fabricated of polymer or other materials that abut against the same blocks of adjacent bins when grouping multiple bins adjacently during shipment. In this way, shifting of bins and possible lock damage from exposed locks hitting one another may be prevented. In one embodiment, a special package may be provided to enclose each bin and provide the standoff elements.

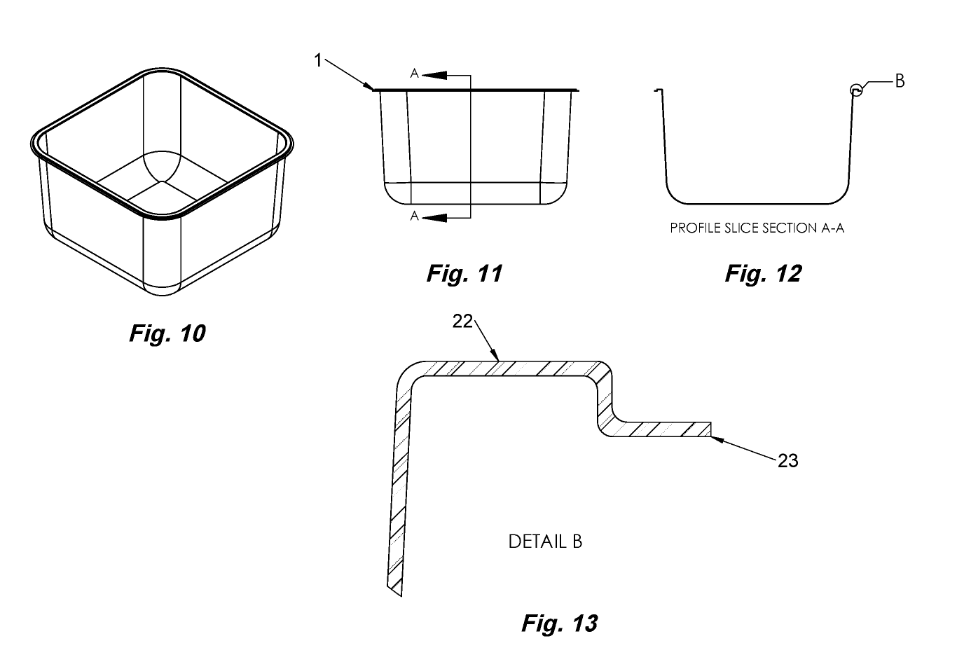

FIG. 10 is a perspective view of the bin of FIG. 1 with the bin lid brackets and locks removed to expose the bin flange. FIG. 11 is an elevation view of bin 1 with section lines A-A to depict a step profile of the bin flange. FIG. 12 is a section view of bin 1 taken along the lines A-A of FIG. 11. Referring now to FIG. 12, a step profile for the bin flange is highlighted as detail B.

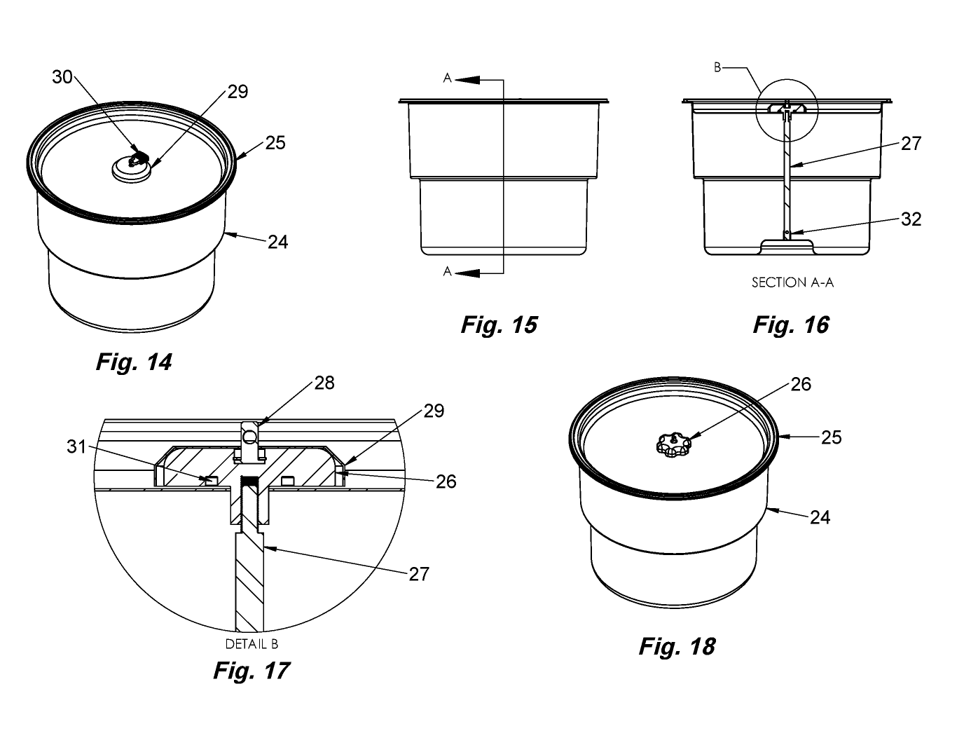

FIG. 13 is an exploded view of detail B of FIG. 12 depicting a step profile geometry to add rigidity support to the overall flange. The top of the flange is a sealing surface 22. Surface 22 interfaces with a gasket such as O-ring gasket 3 of FIG. 4. In one embodiment, the flange is welded to the bin and may be thicker than the bin wall. In this view, a step profile 23 is depicted wherein the bin flange extends past the lock support surfaces 21 depicted in the bracket of FIG. 9 and may rest on the front “step down” surface at the front of the support bracket. The bracket provides vertical support to both undersides of the bin flange depicted in profile 23.

FIG. 14 is a perspective view of a containment system according to another embodiment of the present invention. The containment system includes a drum 1 that may be referred to in some embodiments as a container, canister, receptacle, or barrel. For the purposes of discussion, the term bin is used throughout this specification. Bin 24, unlike bin 1, is annular or cylindrical and somewhat conical. Bin 24 may be a deep drawn stainless-steel bin, or a stainless-steel bin welded from sheet metal parts without departing from the spirit and scope of the present invention. In any embodiment described herein, the bin may be comprised of a rigid or semi-rigid material. The rigid or semi-rigid material may include stainless steel, reinforced stainless steel, steel, aluminum, reinforced aluminum, any other metal, metal alloy, plastic, or any combinations thereof. The bin is in a preferred embodiment, comprised of stainless steel or reinforced stainless steel.

Bin 24 is geometrically annular and includes an upper segment and a lower segment. However, that is not a requirement to practice the invention as described above relative to bin 1 of FIG. 1. In any embodiment described herein, the bin shape may be substantially cubical, rectangular, hexagonal, prism, conical, frustuminal, cylindrical, or any other three-dimensional shape without departing from the spirit and scope of the present invention. Bin 24 has rounded or otherwise smoothed peripheral edges in this example, but may also include one or more sharp edges as may be dictated by design.

Bin 24 has a wall thickness and a floor or bottom wall thickness substantially sufficient to withstand bulging due to gas buildup or internal collapse under vacuum pressure relative to the volume capacity of the bin. Bin 24 is adapted with an open top and a flange or top surface for accepting a bin lid 25 having a channel or furrow for a lid gasket. The top lip or flange portion of bin 24 may be reinforced or otherwise stiffened by hardening or other material straightening fabrication methods.

Bin 24 may be nested vertically owing to a segmented design including an upper segment and a lower segment, the upper segment having a greater diameter than the lower segment. Both the upper and lower segments of bin 24 are concentric and one empty bin may be nested into another. Bin lid 25 includes a central opening provided there through for facilitating a central lid tighten and lock system comprising a threaded post (not illustrated), a turn knob (not illustrated) threaded onto the threaded post. A spin shield 29 may be placed over the turn knob and made to spin freely wherein lock 30 may lock spin shield 29 to prevent unscrewing of central turn knob beneath. Although not depicted in this embodiment, bin lid 25 may also support a valve, such as valve 6 depicted in FIG. 1, or any other valve known in the art and described herein.

FIG. 15 is an elevation view of the bin of FIG. 14 with section lines A-A. In this view bin 24 is comprised of segments, an upper segment and a lower segment. The upper segment has a greater diameter than the lower segment and both segments are concentrically aligned and share the same vertical axis. In one embodiment, bin 24 is welded together from the fabricated segments. In one embodiment, the separate segments of bin 24 might be attached together and may include an O-ring gasket to ensure a hermetic seal between the segments. A welding flange may be provided, in one embodiment, to aid in welding the two different diameter segments together. In another embodiment the upper segment has a lower flange lip that turn in to lessen the welding gap. In a variation, the lower segment may include an upper flare out or flange for aiding welding. Bin 24 may also be a contiguous part if molded or cast.

FIG. 16 is a section view of the bin of FIG. 15 taken along section lines A-A. A center locking post or rod 27 is provided of a length sufficient to exceed the height dimension from the bottom of the bin at center (recessed) to the lid surface (recessed). The bottom (outer) surface of bin 24 is recessed or drawn in at center conforming to a diameter that is sufficiently larger than the turn knob so that one locked bin may be stacked (nested) directly on another during storage or transit. Center rod 27 may be a stainless-steel (or other metal or rigid material) part connected by spring pin or lock pin (removable) to the bottom wall of the bin by brackets 32 welded to the bottom wall bordering center.

Rod 27 includes external threading at the free end to accept a female threaded turn knob. Alternatively, rod 27 may be replaced by a rod that includes internal threading at the free end to accept a male threaded turn knob. Rod 27 may be a cylindrical rod, or may include facets such as a hex or rectangular rod. Bin lid 25 may have an identical edge profile as bin lid 2 with the only difference being that it is annular instead of square. However, the central locking method to obtain a hermetic seal obfuscates external brackets and locks of bin 1. The volume of bin 24 may be identical to or very similar to the volume of bin 24. It may be scaled up or down depending upon market and need. FIG. 16 depicts a detail B highlighting apparatus at top center of rod 27 for more detailed explanation.

FIG. 17 is an exploded view of the rod and turn knob interface for locking down the bin lid and achieving a seal. Rod 17 is externally threaded at a top portion thereof to accept the internal threading of a turn knob 26. Turn knob 26 may be a stainless-steel part or a part fabricated of another rigid material. Turn knob 26 includes a threaded hollow stem for mating to the top threaded portion of rod 27. The central opening of the bin lid is large enough to accept the outer diameter of the threaded portion of knob 26. An annular groove may be provided in the underside surface of knob 26 to provide a seat for an O-ring gasket 31 (round, rectangular). The groove may be largely concentric with the knob profile and central opening.

Detail B includes a pin lock mechanism 28 attached to the top portion of the turn knob (within counter bore). Pin lock mechanism 28 may be used to secure spin shield 29 down over knob 26 so that knob 26 may not be turned when the bin is locked and being shipped. In this example tightening down on knob 26 tightens the bin lid down onto the bin top surface in a fashion that distributes force radially from the center of the bin to the edge.

FIG. 18 is a perspective view of bin 24, lid 25, and knob 26 installed without slip shield 29 and lock 30. Knob 26 may be knurled or otherwise formed or machined to provide an ergonomic gripping surface for a user turning the knob. Other types of knobs may be used without departing from the spirit and scope of the present invention. For example, a turn knob may have opposing elongated handles, or perhaps an equally spaced apart pattern of handles thereon to provide extra leverage in turning, and perhaps rigidity support for the surface of the lid.

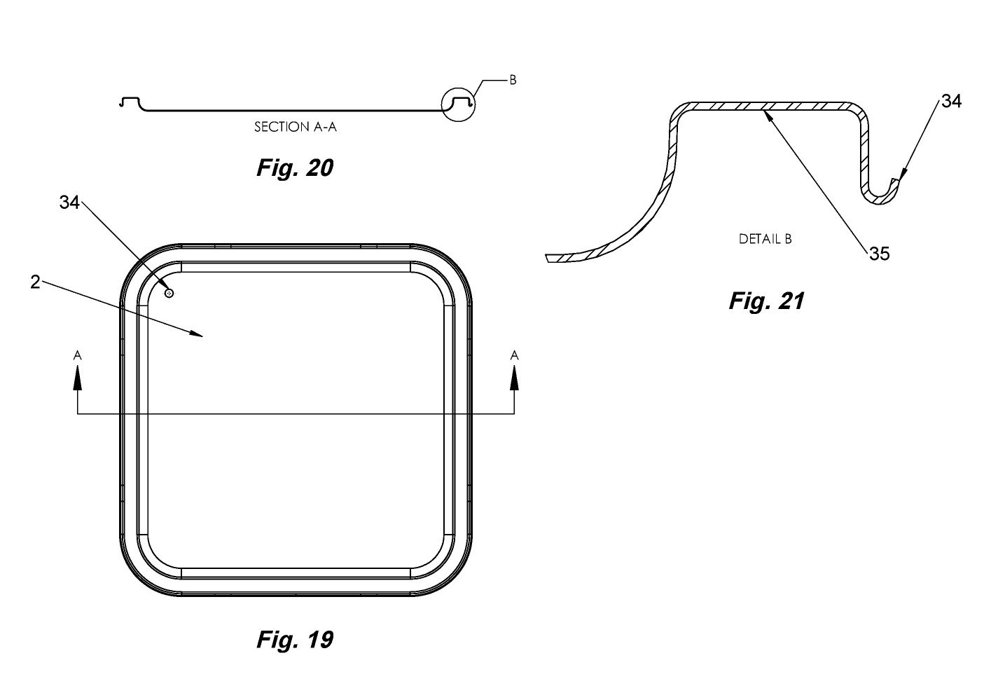

FIG. 19 is an overhead view of the square bin of FIG. 1 with section line A-A depicting lid 2. Lid 2 includes an opening for the pressure equalization valve 6 of bin 1 of FIG. 1. As previously described, lid 2 extends past the top flange surface of bin 1 and then down over the peripheral edge of the bin flange.

FIG. 20 is a section view of lid 2 taken along section line A-A of FIG. 19. Lid 2 is formed to fit over the bin flange as depicted herein by detail B. FIG. 21 is an exploded view of detail B of FIG. 20. To the left of the detail is a radius resultant from a deep draw process to form the lid. The radius provides rigidity support to the lid wall.

The recessive feature 35 results from the extension of the edge of lid 2 past the flange of the bin and then back down the flange side wall. O-ring gaskets may be protected within lid 2 tucked into recessive feature 35, which amounts to a groove extending around the bin to seat the gasket. The material edge of lid 2 is turned up in a hook-radius to serve as a latch catch lip 34. The rounded bottom of lip 34 may serve as a prying point if a prying tool is required to unseal the lid. One with skill in the art will appreciate that there may be some variation in the exact profile shape formed into the edge of the lid.

In a preferred embodiment, the lid comprises a latching flange (lip 34) and O-ring/gasket groove (feature 35). The O-ring/gasket fits snugly within the O-ring/gasket groove, creating an airtight or a substantially airtight seal. The latching flange provides a point for lock latches to affix the lid to the gasket and bin. The latching flange also provides a means for disengaging the lid from the bin, or a handle for picking up the containment system.

The O-ring/gasket groove is shaped such that it can snugly accept an O-ring gasket including, but not limited to, a cylindrical, semi-cylindrical, square, rectangular, triangular, oblong, elliptical, or semi-elliptical gasket. The O-ring/gasket groove may be deep or shallow. In an alternative embodiment, a groove for an O-ring may be disposed on the flange sealing surface instead and such a groove may be sized to accept the gasket diameter wherein that diameter may be significantly smaller than the inside dimension across feature 35 without departing from the spirit and scope of the present invention.

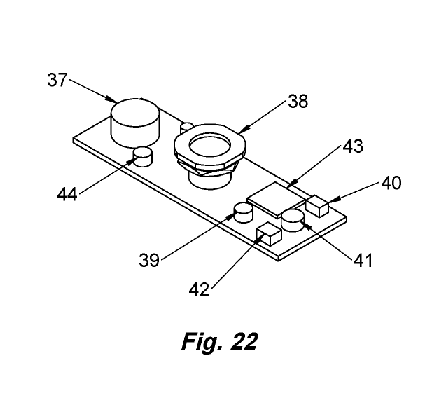

FIG. 22 is a block diagram in perspective view depicting a sensor-loaded circuit board that may be installed onto or within the internal space of a containment bin such as bin 1 or bin 24. The circuit board (telemetric device or system) may include an oxygen sensor 37 adapted to detect and report the percentage of oxygen by volume within the bin when the bin is closed. The circuit board may include a relative humidity sensor 39 to detect and report the percentage of humidity within a closed and sealed bin. The circuit board may include a moisture content sensor 40 to detect moisture levels by percentage of the organic content within a closed and sealed bin. Moisture content may be a different reading than relative humidity in a same bin at a same measurement period.

The circuit board may include a temperature sensor 41 to detect and report current temperature inside a closed and sealed bin. The circuit board may include a digital pressure sensor 42 to detect and report pressure (air pressure, gas pressure, vacuum pressure) within a sealed and closed bin. An analog pressure gauge connected to a valve such as valve 6 of FIG. 1 may also be used to check gas or air pressure within the bin or vacuum pressure within the bin. The circuit board may in one embodiment contain a small system on a chip (SoC) 43 that may function as a processor of information and may extrapolate data and perform routine calculations on data before it is accessed or reported.

The circuit board may include a hermetically sealable electrical connector 38 that may be installed in a provided opening in the bin wall or in the bin lid surface in such a manner that it uses an O-ring gasket and creates a seal, so gas or liquid cannot penetrate the connector seal into the bin volume. Connector 38 may be socket adapted for universal serial bus (USB) communications (wired or wireless) meaning that cabled or wireless transmission of data collected may be accessed by or sent to a remote station or device such as a smart phone or a Laptop computing device. Connector 38 may be a wireless transceiver device and a cable socket or simply a wireless transceiver (node) or simply a cable socket or connection plug.

In one embodiment, each bin may have a display device mounted thereon wherein the display device is connected to the circuit board and displays various states of the inside of the bin and of the contained materials right on the side exterior wall or on the top surface of the lid. In such an embodiment, the display device may be wired to the sensor-based circuit board internally and there may be a power button on the display device to power on or off the sensors and display device. In one embodiment, the circuitry enables data collection, data processing, value calculation, data transmission, and data reception. Sensors may be loaded on the board or they may be distributed within the bin and report to the board wirelessly or over traces or cables.

There may be more or fewer sensors and sensors of different types of included within a containment system (bin) without departing from the spirit and scope of the present invention. Sensors may include, but are not limited to, a relative humidity sensor, SoC, barometer (air pressure sensor), thermometer (temperature sensor), and moisture content sensor. Any known sensor in the art may be mounted to the circuit board. The circuit board may be located on the inside of the lid, the floor of the bin or any interior substantially flat side of the bin. The circuit board may be attached to the containment system, permanently or temporarily, using magnets, epoxy, glue, hook and loop binding (such as Velcro), or any other means for attachment.

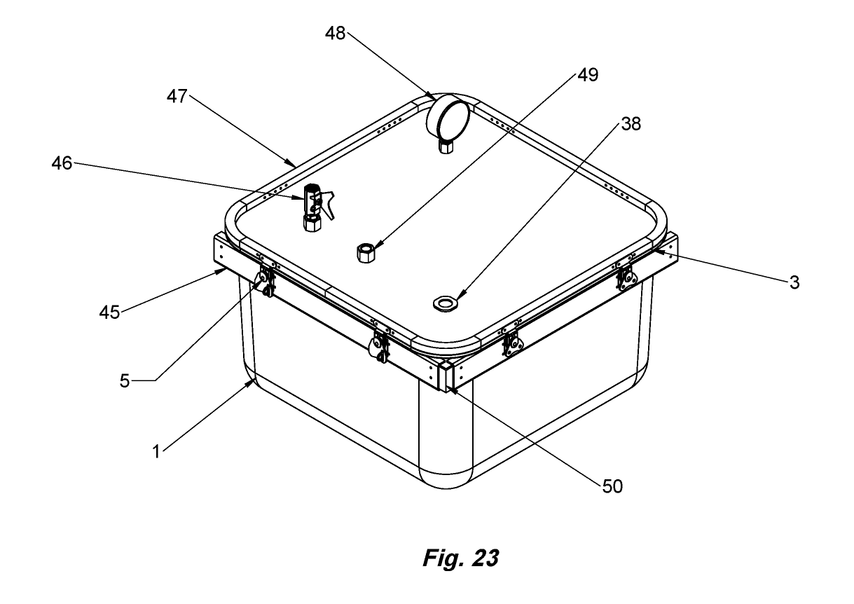

FIG. 23 is another embodiment of a containment system, illustrating a perspective view of bin 1 of FIG. 1 with a bin sleeve reinforcement apparatus in place of support brackets 4 (detail B FIG. 4). Bin 1 includes a flange that may be rigidly supported using a bin sleeve apparatus comprising a number of bin sleeves 45 (one per side 4 ea.). Bin sleeves 45 are connected together to form a frame via corner brackets 50 (one per corner 4 ea.). Bin sleeves 45 and corner brackets 50 may be manufactured from stainless steel or other rigid or semi-rigid materials. In another embodiment, the bin, the bin sleeve, and the lid are comprised of and/or coated with a plastic that is not porous to oxygen, other gases, or water. The plastic (or plastic coating) described herein may be any plastic, but is preferably polyvinyl alcohol copolymer, which is sometimes called EVAL or EVOH. In one embodiment, bin sleeves 45 are framed using brackets 50 and then welded as a frame onto the external surface of the bin abutting against the underside of the bin flange to provide rigidity support to the flange. The bin sleeve apparatus may, instead of welding, be fixed to bin 1 using glue, mounting hardware, etc.

In this implementation, the bin sleeve apparatus provides the mounting surface for latch latches 5 (two per bin side, eight per bin). Latches 5 may be mounted to or welded to respective sleeves in a fashion as to ensure they are equally spaced apart and that they are all in line relative to latch reach and clamping force, which is equalized by positioning across the plurality thereof around the bin. The bin apparatus replaces the use of flange brackets 4 of FIG. 4. Also in this implementation, lid 2 is substituted herein by a compression frame 47 and a substantially flat lid sheet. The lid sheet may be a stainless steel or aluminum sheet and may be reinforced for rigidity. In one embodiment, the interior or exterior portions of the bin, the bin sleeve, and the lid assembly may optionally include a surface coating anodize coating, paint, rubber, glass, plastic, nanocoating, sealant, any FDA approved material, or any other material having properties to slow or prevent oxidation or any degradation of the material comprising said bin, bin sleeve, and lid assembly.

Compression frame 47 may be a stainless-steel frame or a frame made from aluminum, another metal, or another material with sufficient rigidity to function as a compression frame against the lid sheet. In this embodiment, latch 5 mounted to the bin sleeve apparatus latches onto a latch plate installed on compression frame 47 rather than on a latch lip provided in a lid. In this example, the latches on the bin sleeve apparatus latch to the latch plates on the compression frame urging the compression frame down with force against the lid sheet and ultimately against gasket 3 and the top sealing surface of the bin or the top of the bin flange. In this embodiment, there may be a groove around the bin flange to seat gasket 3.

The lid sheet may host a variety of parts such as hermetically sealed connector 38 for accessing data from the single circuit board (sensors on board or distributed within bin). As described further above, a display might be provided so that a user may simply push a button (powering up the sensor board) and then view the readings from sensors on that display device. In one application, a battery for the sensor circuitry may be provided to fit in a compartment in the display device framing hardware. A display device may be a light emitting diode (LED) display, an organic LED (OLED), or another type of display.

In this example, lid sheet includes a pressure equalization valve 49 analogous to valve 6 of FIG. 1, and analog pressure gauge 48. Lid sheet also includes a ball valve 46 that may be used to flush the bin with nitrogen or another inert gas or used to flush during a curing stage where the organic product cures inside the bin while stored therein. Ball valve 46 may be another type of valve such as a quarter-turn valve, check valve, gate valve, pressure-reducing valve, or other types of valves.

In one implementation, the compression frame 47 and lid sheet are fixed together via weld or other fastening hardware. The lid sheet has enough rigidity and strength to remain substantially flat when subjected to any force created by a pressure differential between the interior and exterior of the containment system or any force created under the weight of at least one containment system stacked upon the lid sheet. In another implementation, the lid sheet may be rigidly supported by a rib structure comprising areas or swaths of thicker sheet material perhaps on the underside of the sheet that emanate from a thicker center and span out to the corners and mid-section points between the corners of the lid sheet.

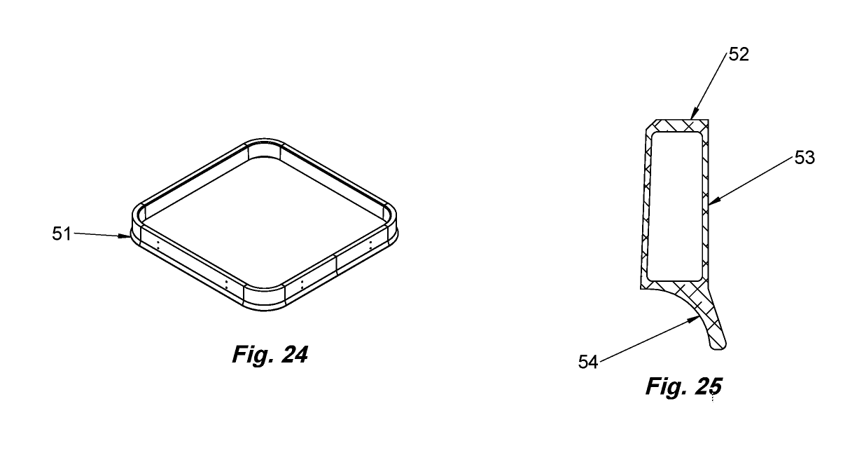

FIG. 24 is a perspective view of a bin sleeve 51 according to another embodiment of the present invention. Bin sleeve 51 is a one piece implement in this embodiment. In this case, the sleeve, which may be manufactured of stainless steel or aluminum or any other materials that are sufficiently rigid comprises four sleeves and four radiused corner pieces. These are welded together in one instance to form a single piece bin sleeve. In all embodiments, the bin sleeve reinforces top edges of the bin or the bin flanges, such that the top edges of the bin or the bin flanges remain rigid under the weight of other stacked bins and internal vacuum pressure. The bin sleeve also distributes force from the latches across the bin flange, and ultimately ensures a substantially airtight seal or an airtight seal when the latches are shut. The bin sleeve is typically permanently affixed to the bin but may optionally be removable. The bin sleeve may be a separate component that is permanently affixed to the bin or a part of the bin itself created by extrusion, cast-molding, or other known manufacturing process.

FIG. 25 is a section view of bin sleeve 51 of FIG. 24 taken along a center line. Bin sleeve 51 is hollow and may be welded together using rectangular tubing in one embodiment. Surface 53 is the lock mount surface that faces outward. Top surface 52 is thicker than the side walls of the sleeve and abuts against the underside of the bin flange to provide rigidity support. In this implementation, a bin lift interface or handle lip 54 is provided to enable a machine to lift the bin. Handle interface 54 may extend all the way around bin sleeve 51 and may be welded to the lower surface of the bin sleeve. In one embodiment, there are two handle interfaces 54, one on each side of the bin. In another embodiment handle interface 54 is contiguous to the rest of the bin sleeve and may be formed or stamped or machined from a thick wall without departing from the spirit and scope of the present invention. In yet another embodiment handle interface 54 may be produced during material extrusion, cast-molding, or other known manufacturing process for extruding, forming, stamping, broaching, bending, or shaping metals.

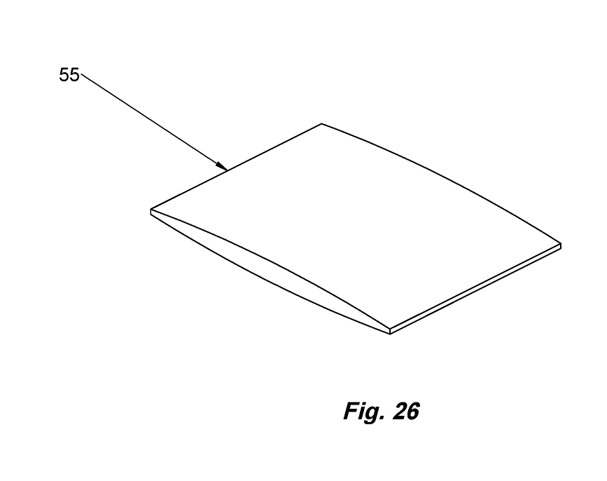

FIG. 26 is a perspective view of an oxygen absorbing pack or packet 55 used to reduce the amount of oxygen in a containment system bin. The inventors sometimes refer to these off-the shelf packets or sachets as “Nitropax”. These packets may be placed inside a bin with product to reduce the levels of oxygen by absorption.

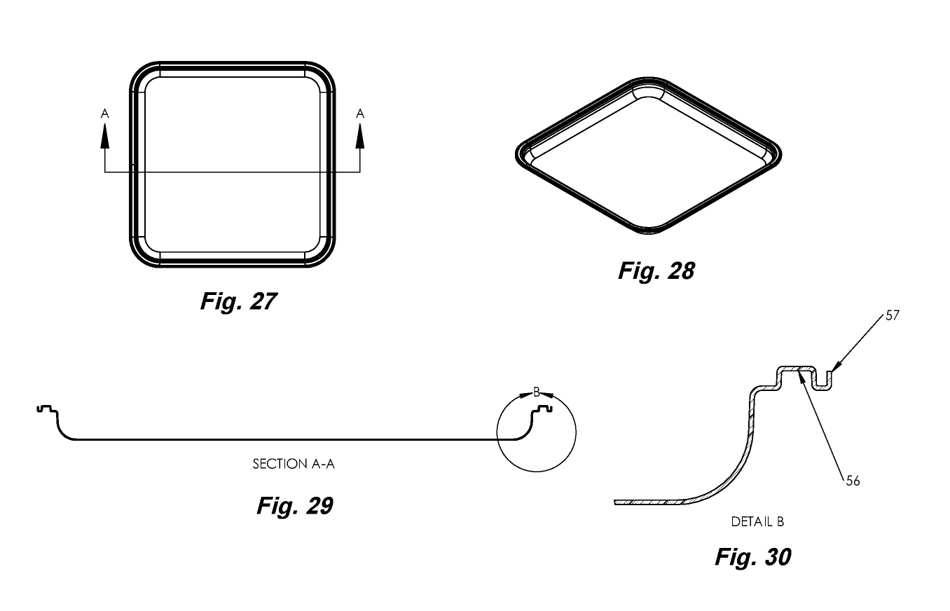

FIG. 27 is an overhead view of a bin lid having a different edge design than bin lid 2 of FIG. 19. In one embodiment, the bin lid may be recessed or deep drawn to a lower horizontal plane than lid 2 of FIG. 19 has. FIG. 28 is a perspective view of the lid of FIG. 27. FIG. 29 is a section view of the lid of FIG. 27 taken along section lines A-A. Referring now to FIG. 29, it can be seen that the lid is recessed below the bin flange to a significantly greater degree than lid 2 of FIG. 20. In this view, there is also an additional bend highlighted in detail B formed just above the deep draw radius and before the groove feature of the lid. This additional bend enables the side of the groove feature to remain parallel to one another along the full depth of the groove unlike feature 35 of FIG. 21 depicting radial encroachment of the feature by the radius resulting from the deep draw process used to form the recession of the lid surface to a plane lower than the gasket seal.

FIG. 30 is an exploded view of detail B of FIG. 29. In this view, it can be seen that groove feature 56 is formed wherein the more external wall of the groove feature extends down on the outside of the bin flange and then hooked back upward to form latch lip feature 57. At the opposite side of groove feature 56, the lid extends horizontally for a short distance before the top end of the radius formed through deep drawing the lid. This short horizontal feature may also aid in providing relief between the inside wall surfaces of the bin and the radius formed as a result of deep drawing the lid.

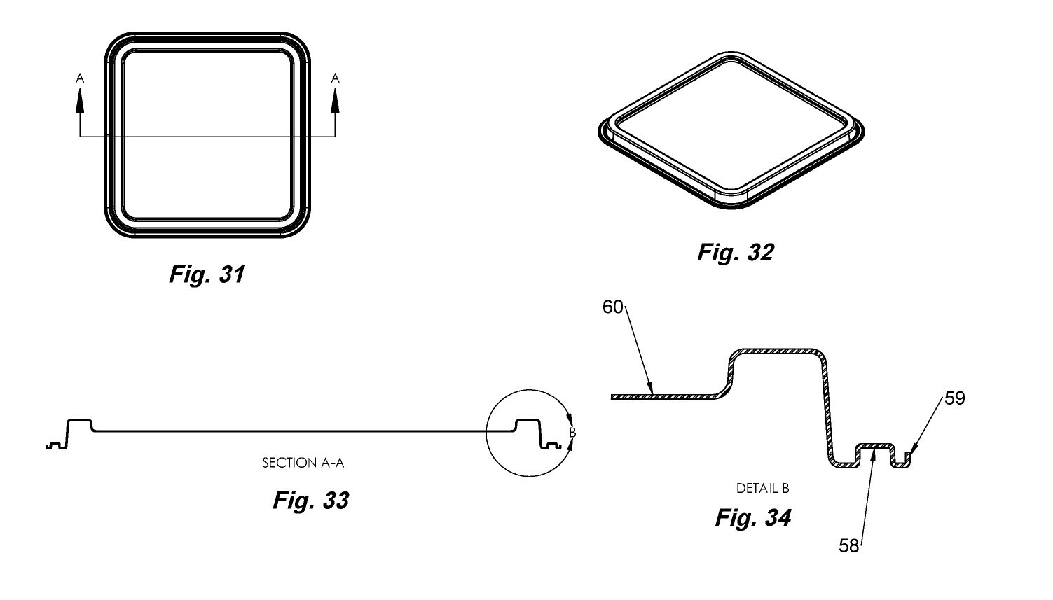

FIG. 31 is an overhead view of a bin lid having a raised surface profile instead of a recessed surface profile edge design similar to lid 2. In this view, the bin lid is raised, meaning that the lid surface is raised significantly above the plane of the flange top. In this example, the deep draw process may still be employed to draw the sheet section down from the top relative to the top surface thereof and the groove and latch lip orientation. FIG. 32 is a perspective view of the bin lid of FIG. 31 depicting a raised lid surface. FIG. 33 is a section view of the lid of FIG. 32. The bin lid in this depiction is recessed a lesser amount and the raised feature resides within the footprint of the bin. The lid is again drawn down from the raised feature toward a groove feature and latch lip feature as depicted herein by detail B.

FIG. 34 is an exploded view of detail B of FIG. 33. It can be seen in this view that surface 60 of the lid is raised significantly above groove feature 58 but resides significantly below the top surface which would be the interfacing surface in bin stacking protecting the lid surface 60 altogether. This raised feature in the lid also sets within the footprint of the bin itself. Groove feature 58 and latch lip 59 are unchanged from the lid of FIG. 30. Other designs may be observed for a bin lid without departing from the spirit and scope of the present invention.

The gaskets described herein used with the various embodiments may be comprised of any known gasket material, including, but not limited to, any rubber, nitrile, silicone, metal, neoprene, buna-N, Viton™, butadinene rubber, styrene-butadinene rubber, chlorosulfonated polyethylene, epichlorohydrin rubber, ethylene propylene diene monomer, ethylene propylene rubber, fluoroelastomer, perfluoroelastomer, polyacrylate rubber, butyl rubber, polysulfide rubber, polytetrafluoroethylene, sanifluor, fiberglass, or any other plastic or polymer, thermoplastic elastomer, styrenics, thermoplastic polyolefin, LDPE, HDPE, LLDPE, ULDPE, thermoplastic polyurethane, polyether, polyester, thermoplastic etheresterelastomers, copolyesters, thermoplastic polyamides, polyamides, melt-processible rubber, thermoplastic vulcanizate, copolymers of hexafluoropropylene (HFP) and vinylidene fluoride (VDF or VF2), terpolymers of tetrafluoroethylene (TFE), vinylidene fluoride (VDF) and hexafluoropropylene (HFP), perfluoromethylvinylether (PMVE) containing polymers, any FDA approved material any food safe material, or any combination thereof. The gasket may be any thickness and shape that has the means to make a hermetic seal with the lid and bin flange. The gasket may be a separate piece or may be built into the lid or the bin flange.

In one embodiment, the bin may be created from a re-purposed or modified kitchen sink. In another embodiment, the bin provides a surface on which to attach a tracking device, including but not limited to GPS, RFID, or QR coding device. Said tracking devices may be permanently affixed to the interior or exterior surface of the bin or may be incorporated into the walls of the bin itself (as opposed to being attached to the surface). Alternatively, the tracking devices may be removable. Tracking devices further comprise or store thereon software enabling a user to track the bin location.

In one embodiment a location, pocket or slip for signage, branding, traveler documentation, storage documentation, a manifest, or other useful information, including a bin identification number may be provided on the bin. The location may be on the side of the bin to secure important documents to the containment system. Said documents optionally identify the contents of the containment system, date of packing contents, expiration date, and other relevant information required by law, such as a manifest. The information may be for the convenience of the user or mandated by law. Additionally, the bin sleeve may have a location where you can identify a shipment by an ID number, bar code, lot number, or other similar marking. In other embodiments, said information may be secured on the lid, side of the bin, or any other convenient location on the containment system. This embodiment of the containment system is exemplary, any embodiment may include one or more of the features listed above, as well as other active packing components and other features.

In one embodiment, the electrical connector (connector 38, FIG. 23) creates a connection between sensors or monitoring devices located inside the closed containment system and a battery pack or other component that can transmit information wirelessly or otherwise to a computer, tablet phone, or other electronic device. Alternatively, the electrical connector can connect to externally located lights, indicator lights, sirens, bells or other devices that alert users of changes to the internal atmosphere of the containment system.

Any data drawn from the sensors may be made available via a web interface, tablet interface, or mobile device interface. Optionally, the containment system may include a monitoring system that monitors and tracks the containment system. In one embodiment, the monitoring system determines if the containment system has a leak, or has been opened, by detecting pressure changes, or internal gas compositions. In another embodiment, the monitoring system may track the geographical location of the device, and what occurs at any given location. Although Nitropax (oxygen absorbers) and two-way humidity control packs may be located anywhere inside the closed containment system however, it is preferable that they are kept separated from the stored crop or perishable goods. Packets or sachets containing oxygen absorbers and two-way humidity control packs may be held to the wall of the bin using magnets or by other means. The oxygen packets are optionally sealed such that only air molecules may enter and exit the packet. Two-way humidity packs, such as the range of two-way packs provided by Boveda, or any other supplier, may be used with the containment system.

Options for atmospheric control packs may include the oxygen absorber, which may scavenge or absorb oxygen by any ferrous means or non-ferrous means. In one embodiment, the oxygen absorber uses an alkaline solution of pyrogallic acid. In another embodiment, the oxygen absorber is a scavenger sachet using iron powder, a mixture of iron powder and sodium chloride, or another catalyst to activate oxidation. Alternatively, the oxygen absorber comprises ferrous carbonate ascorbate, sodium hydrogen carbonate, citrus, and a metal halide catalyst. Alternatively, oxygen absorbers may comprise sulfur compounds or aluminum compounds.

In still another embodiment, the oxygen absorber may comprise oxygen-scavenging polymers or ascorbic acid. Optionally, any oxygen scavenger described herein may further comprise activated carbon, which will absorb other gases and organic molecules to further preserve perishable goods and remove odors. In another embodiment, oxygen is removed from the interior of the containment system via gas-flushing or compensated vacuum pump, EMAP, or any other method known in the art. These methods used singularly or in combination reduce the oxygen-level interior atmosphere of the containment system to less than 5%, 4%, 3%, 2%, 1%, 0.5%, 0.1%, or 0%.

In one embodiment locks used to latch down the bin lid may include a latch keeper and a latch lock joint. The lock can be any type of lock, and may also be outfitted with any known locking device, including but not limited to a pad lock, a combination lock (digital or analog), Z-Wave controlled lock, ZigBee controlled lock, RFID controlled lock, Bluetooth controlled lock, BPS controlled lock (only opens when it arrives at a previously configured geographic location), a lock that is operated by timer, a lock requiring a user to solve a math problem, biometric lock (finger printing, DNA, eye, etc.), or any other lock.

Any embodiment described herein may further comprise an apparatus for temperature control, temperature monitoring and/or an insulating layer of material, to modulate temperature of the interior atmosphere of the containment system. The containment system may store perishable goods at a constant temperature between −25 to 75 degrees Fahrenheit, and more preferably perishable goods are maintained at approximately 35, 40, 45, 50, 55, 60, or 65 degrees Fahrenheit. The containment system may be fabricated of materials and components that are compatible with cold or freezing temperatures, and all metals, rubbers and other materials may be selected to be used in those conditions. Certain inert gasses may also be used to help maintain temperature within the containment system.

Any embodiment described herein may further comprise an apparatus for moisture control, and/or moisture monitoring to modulate moisture of the interior atmosphere of the containment system, and the goods therein. The containment system may store perishable goods in an atmosphere with a constant humidity between 10 to 75% relatively humidity, and more preferably is maintained at approximately 10, 15, 20, 25, 30, 35, 40, 45, 50, 55, 60, 61, 62, 63, 64, 65, 70, 75% humidity, and resulting in the same humidity or moisture levels for the perishable goods contained therein.

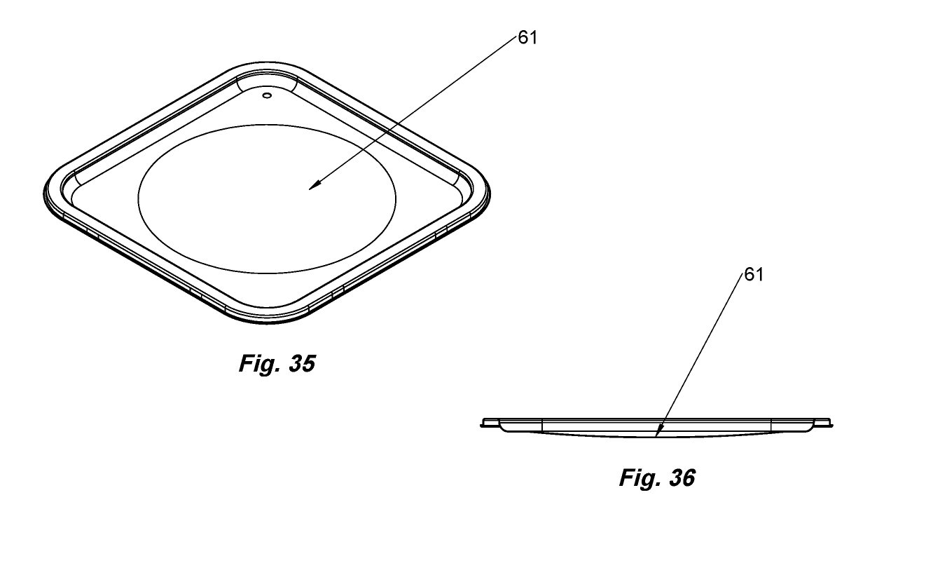

FIG. 35 is a perspective view of a bin lid according to another embodiment of the invention. In this view, a square bin lid is provided that includes, in addition to the drawn down section, a centralized area configured as a pop up bubble surface 61. Bubble surface 61 may be a contiguous part of the bin lid or stainless steel machined to a thinner thickness dimension to allow for the flex of popping up or popping down. Bubble feature is annular in this case, but may be elliptical or oval without departing from the spirit and scope of the present invention.

FIG. 36 is a section view of the lid of FIG. 35 taken generally along the center line of the lid. In this view, bubble feature 61 extends as a shallow radius below the relatively flat plane of the bottom or drawn down lid surface of the bin lid. Bubble feature 61 may also be provided in the other lids mentioned in this specification including a lid sheet as described herein and any bin lid that is not drawn down.

Bubble feature 61 may be engineered to be popped upward under no force or pressure until a lid is positioned over and attached onto a bin, and a vacuum drawn on the bin with a pump or as a result of oxygen absorbers or scavengers as they are sometimes referred to in the art. Bubble feature 61 may be engineered by controlling diameter and material thickness to pop down when a certain vacuum pressure threshold value or minimum vacuum pressure exists within the bin. When the threshold is reached the bubble feature will pop down and will remain popped down while the vacuum pressure is present at least at the threshold level functioning as a visual indicator to a user and as a leak indicator for a bin that cannot maintain the vacuum due to damage or seal leak.

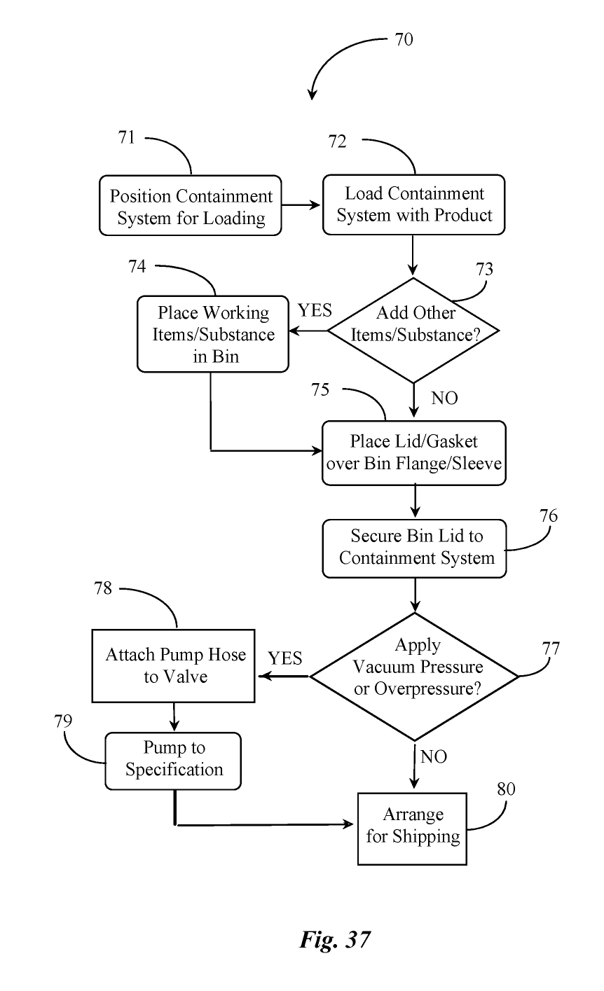

FIG. 37 is a process flow chart 70 depicting steps for loading a containment system to ship according to an embodiment of the present invention. At step 71 a user may procure or otherwise acquire a containment system as described in various embodiments herein and may position that system for loading of an organic product including but not limited to tobacco, hops, marijuana, hemp, teas, herbs or other stored goods described herein. It might be assumed in this point in the process that the bins and lids have been sterilized and otherwise preprocessed to ensure they are clean and ready for loading product.

At step 72 a user or in one case an automated loader, hopper, or other machine may load the containment system with product. It may be assumed in this process that curing of product may occur within the bin while the product is being stored and or shipped. In one aspect of the process there may be separators and or partitions provided with the containment system for separating products or amounts thereof, or used to keep the product level in the bin or from clumping or bunching as was described with reference FIG. 1.

At step 73, a user may determine whether to add other items and or substances to the product or otherwise into the bin for the purpose of treating the product or monitoring various product states. Items and substances may include but are not limited to oxygen scavengers, two-way humidity control devices and or packets, products that release moisture such as wet paper towels, terpenes (aromatic organic compounds), mold inhibitors, parasite inhibitors, or the like that might be delivered in a variety of methodologies including powder dispersal, liquid dispersal (wash), gel dispersal, aerosol dispersal, or other methods, either by automated or manual dispersion into the bin.

If it is determined by human or by automated assistant that one or more items or substances are to be included in with the product, at step 74 those items and or substances are placed into or otherwise dispersed into the bin with the bin product. In one embodiment, an item placed into the bin may be an electronic device or circuit for monitoring product state, temperature, humidity, and other conditions such as parasitic involvement or the involvement of mold or other pathogens that may be affecting the product or may develop within the product after it is sealed within the bin. In a preferred embodiment any items and or substances placed within or otherwise dispersed into the bin are purposed items or substances dedicated to preservation of the integrity product within the bin and might change depending upon the exact product type placed into the bin.

If at step 73 it is determined not to add an item, items and or a substance, then the process moves to step 75. At step 75, a user may place the bin lid and gasket (typically recessed in a groove on the underside of the lid), onto and against the bin flange or bin sleeve (if equipped). After step 74, the process also moves to step 75. At step 76 the user may secure the bin lid to the containment system. In this step, the bin lid is typically secured by a series of lever or spring latches such that when they are positioned (latches over bin latch lip), the user may urge the bin lid down at opposing sides (two or more latches per side) to seal the lid down against the bin flange or sleeve firmly sealing the containment system. In one aspect of the process, the latches are lockable to prevent unintended opening. Locks may also be enabled to lock or unlock via a wireless signal from an authorized source such as an inspector, for example.

In another embodiment, after step 76, the bin may be opened and the user may return to step 72 or step 73. Alternatively, it may be opened, emptied, optionally cleaned, and the user may return to step 72.

In one aspect, depending upon the items placed in the bin at step 74, a decision might be at step 77 whether to apply vacuum pressure or overpressure (overpressure means pressure in excess of atmospheric pressure) to the bin using one or more valves provided in the bin. If it is determined at step 77 to apply vacuum or overpressure to the bin, the process may move to step 78. A step 78 the user may attach a hose from a vacuum or pressure pump to a valve on the bin such as a ball valve attached to a pressure gauge. A pressure gauge may also be provided connected to a separately provided valve.

At step 79, the user may pump air in or out to a specification that may be displayed on the pressure gauge. At step 77, if it is determined that no vacuum or overpressure will be applied to the bin, then the process may move to step 80 where a user may arrange for shipping or transporting the bin. After step 79, the process moves to step 80. Shipping arrangements may vary widely depending upon product type number of bins containing product in one shipment, etc. For example, bins may be placed in or on pallets, on shelving, in freezers, in refrigerators, in larger steel shipping containers, in trucks, on flights, or other transportation staging and vehicle. Likewise, a product may be loaded as described in process 70 and stored instead of shipped right away such as storing the bin or bins loaded with product in a warehouse, a dry room, a greenhouse, a bunker, a train car, or other storage space.

In one aspect of the process bins may include collars or standoffs to prevent one bin from physically coming into contact with another bin. In another aspect, gauges, valves, that might stick out beyond an acceptable distance from the bin may be removed and stored separately during shipment such that they may be retrieved anytime during a shipment or after arrival and reattached to one or more than one bin for inspecting pressure, flushing, burping, or conditioning, product within the bin or bins.

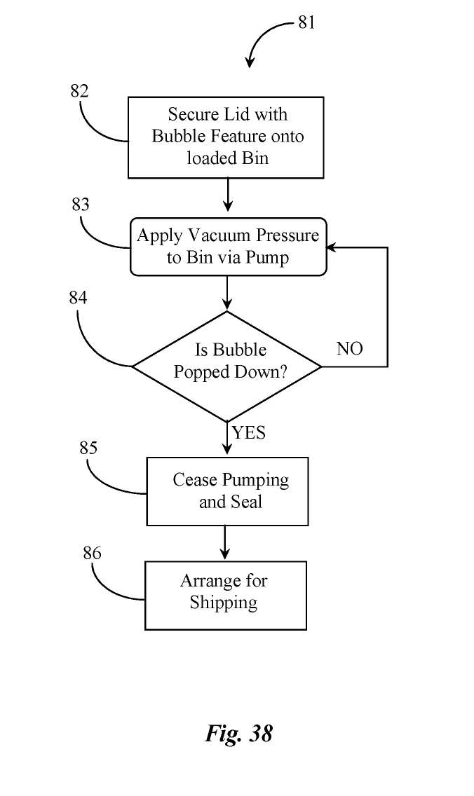

FIG. 38 is a process flow chart 81 depicting steps for applying vacuum or overpressure to a specified pressure according to an aspect of the invention. It may be assumed that in this process at least one bin has been loaded with product for shipment or storage accordingly as described in steps 71 through 75 of FIG. 37. In this process the bin lid includes a pop up bubble feature such as lid surface feature 61 described above relative to FIG. 35.

At step 82 a user may secure the lid with the bubble feature onto the loaded bin using latches and locks if applicable to seal the bin and product inside hermetically. At step 83, a user may apply vacuum or overpressure to the loaded bin in a similar fashion as described above relative to steps 78 and 79 in process 70 of FIG. 37. At step 84, a user may visibly determine if a vacuum exists by looking at whether the pop up bubble feature is popped up or popped down.

At step 84, if the user is attempting to establish a vacuum condition and the user determines that the bubble feature has not popped down, the process resolves back to step 83. If at step 84 the user determines that the bubble feature has popped down, then at step 85, the user may cease applying vacuum and seal such as by shutting and sealing the vacuum valve and disconnecting the vacuum hose from the bin valve. At step 86 the user may arrange the bin or multiple bins processed for shipping in ways described further above relative to step 80 of process 70 of FIG. 37. If the user does not wish to create a vacuum, the user can simply go to from step 82 directly to step 85 in FIG. 38.

In one aspect, the bin and lid are flexible to a degree as to breath in or out depending on the pressure difference between the inside and outside of the bin. In such a case, the bin sides may be visibly inspected or measured to determine if a vacuum exists (bowed in) or if internal pressure buildup exists (bowed out) within a loaded bin. A dome or bubble feature confirms vacuum exists by popping down while if the dome pops up after a state of vacuum was achieved using this process, then it may confirm a broken seal.

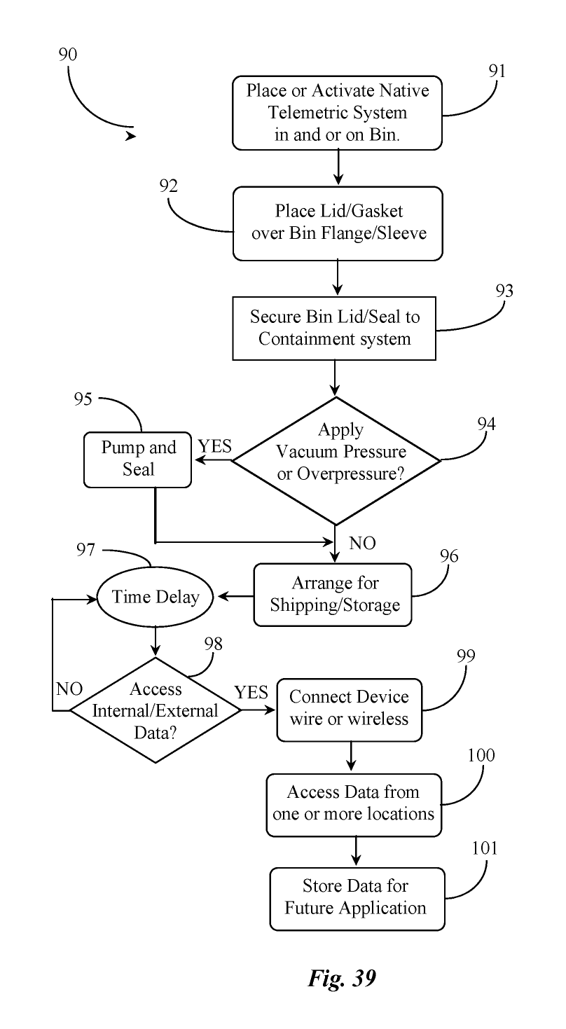

FIG. 39 is a process flow chart 90 depicting steps for accessing state data from a telemetric system native to a containment system. It may be assumed in this process that a bin has been loaded with product including placement of treatment implements and or substances and is ready to accept placement of and or activation of at least one telemetric system within a bin.

At step 91, a user may place a telemetric device or system within a bin for the purpose of measuring and recording state data relative to the inside volume of the bin and the product contained within the bin. In one aspect of the method, one or more telemetric devices or systems may be installed within the bin during manufacture of the bin. In yet another aspect, a telemetric device or system may also be attached to the outside of a bin or one telemetric system may include sensors both within and outside of a bin.

At step 92, a user may place a bin lid and nested gasket over the bin flange or bin sleeve (if equipped) and may then seal or secure the bin lid down to the containment system at step 93 affecting a hermetic seal. Referring to step 91, it may be that a power source for any telemetric device installed within the bin is refreshed such as by charging or replacing one or more batteries or power cells when the device is incorporated into the containment system architecture. In another aspect of the method, it may be that such telemetric device or system batteries may be charged through the bin wall by a remote charging source through a connector such as connector 38 described further above relative to FIG. 22.

At step 94, a determination may be made by the user whether to apply vacuum or overpressure to the bin containing product for shipment or storage. If the user determines to apply vacuum or overpressure within the bin, then the user may create such a condition using a pump and hose through a valve and seal it off at step 95. The process then moves to step 96 where the user may arrange one or more bins for shipping or storage. At this point in the process one or more telemetric devices may be active within the bin and also outside of the bin if so equipped. In another aspect, telemetric devices may be left off or on but if on powered but in a “sleep” mode (not collecting data) until such time an inspection or monitoring event is warranted. The telemetric device or systems may be powered on or woke from a sleep mode using a remote communications device such as a smart phone, tablet, external computing system, or the like.

While telemetric devices may require time to collect data for access, there may be a delay period or time delay at step 97 wherein the bins are in transit or storage and an inspection or monitoring session is warranted or desired. Such an inspection may involve accessing telemetric data to check various states of the bin and of the product contained within the bin. Exemplary states may include humidity state within the bin volume, mold detection states, contaminant levels, parasitic involvement, potency state, oxygen levels (preferred less than 1% by volume), presence of other gasses, detection of by product gasses, and so on. Other states may involve shipping or supply line concerns such as time in storage, time in dock, GPS location in transit, etc.

At step 98, it may be determined whether to access internal or external recorded data. If it is determined not to access any data to perform an inspection or to offload sensor data, then the process resolves back to step 97 until such action is determined to be appropriate. There may be a time period associated with the delay at step 97 such as check states every 24-hour period for example. If at step 98, it is determined to access state data from the containment system, the process moves to step 99 where a user may connect an access device, typically a smart phone, tablet, or computing system to the containment system using a wired connector and cable such as connecter 38 described with reference to FIG. 22, or by using a wireless protocol such as Blue tooth, wireless USB, or a near field or short range wireless protocol.

Once connected, a user operating the connected access device may, using a software application (SW) application running on the access device, poll or browse the containment system for available data and request access to the data for transfer to the mobile device or fixed computer system or terminal at step 100. Such access may require authentication such as the use of a pass code, personal identification number (PIN), a password, or a combination thereof to retrieve the data.

Also in this step, the user may access shipping data, estimated arrival times, dock times, location, and other pertinent data using the access device or in one case using a scanner device to lift bar code, UPC data, and coded shipping data embedded in a QR sticker, shipping document, or held in hard storage. Relevant paperwork may be made available in a plastic sleeve affixed to the containment system, other data affixed or imprinted or etched temporarily or permanently relative to a containment system may include a manifest shipping envelope, RFID chip data, bar codes, QR Codes, stickers, instructions, warning labels, product inspection schedules, or other notices. In still another variant of this aspect some data may be displayed on a digital display device attached to the bin whereby the user may simply see the data and enter that data into another external system such as a dock terminal.

At step 39, the user may access and store containment bin data for future application such as updating supply chain status data for a shipment to a receiving customer. This telemetric data can be used to check on or monitor the status of stored goods, make changes to stored goods or storage conditions, manage containment system logistics, monitor security states, and mitigate other issues. Optionally, this telemetry data can be automatically or manually entered into other electronic systems including a network server running supportive SW that may also retrieve data from third party storage or systems to aid in the management tasks relative to logistics, supply chain, security, or other issues. There are many possibilities.

Containment bins may be nested in storage or transportation with lids attached or stored on the sides of the bins or in a separate container associated with the bins. Bins may be secured to a vehicle for transportation, including placement within an insulative or refrigeration compartment storage or transport car or carriage. In one embodiment, goods of one type may be transported to a destination whereby the bins may be opened, the product tested and/or removed, and the bin or bins may be returned to the origination point.

In still another variation of this aspect, a bin may be loaded and prepared for transporting goods to a first destination, wherein operators remove the goods at the first destination and then load another product into the bin for delivery to a next destination and so on. In such an embodiment, the containment system may be owned and operated by a shipping company wherein the bins are shared for use in transporting and or storing organic products and wherein the bins may be commercial and fixed or otherwise made integral to a mode of shipping such as integral to a train car architecture, a shipping cargo boat architecture, or an air cargo plane architecture, a truck bay architecture, and so on.

It will be apparent to one with skill in the art that the containment system of the invention may be provided using some or all the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A product containment system comprising:
an open bin having a closed end, at least one side wall, and an open end bordered by a substantially horizontal sealing surface and an internal volume defined by the enclosure below the sealing surface;
a bin lid configured geometrically to fit over the bin;
a gasket disposed between the bin lid and the sealing surface of the bin;
at least one valve incorporated into the bin lid or into the at least one bin side wall.

2. The product containment system of claim 1, wherein the bin is square and includes four bin side walls.

3. The product containment system of claim 1, wherein the bin is annular and has a single cylindrical or elliptical side wall.

4. The product containment system of claim 1 further including a plurality of latch clamps affixed to and strategically disposed about the exterior surface or surfaces of the bin, the latch portion of each clamp latching onto an upwardly hooked lip extending contiguously or in linear distances about the peripheral edge of the lid.

5. The product containment system of claim 3, further including at least one turn knob clamp and a centrally mounted internal rod interface adapted to seat the turn knob through a central opening provided in the bin lid, the turn knob including a gasket disposed between the knob and the bin lid surface.

6. The product containment system of claim 1, wherein the horizontal sealing surface is a top surface of a bin flange extending around the top edge or edges of the bin.

7. The product containment system of claim 1, wherein the horizontal sealing surface is a top surface of a bin sleeve fixed to the top outer edge or edges of the bin.

8. The product containment system of claim 1, wherein the bin lid comprises a compression frame and a bin lid sheet.

9. The product containment system of claim 1, wherein the bin lid is drawn down in manufacturing thereby producing a lid primary surface that resides at a lower horizontal plane than the bin lid edges.

10. The product containment system of claim 6, further including multiple brackets disposed about the external top surface of the bin, the brackets abutting against the under surface of the flange, thereby reinforcing the rigidity of the bin flange.

11. The product containment system of claim 1, wherein the bin further comprises one or more telemetric devices incorporated or otherwise disposed within the bin volume and or on the external surfaces of the bin, the telemetric devices adapted to record and retain data for access by a remote computing appliance, and wherein the one or more telemetric devices is incorporated into the structure of the bin and includes a display device incorporated into the bin or the bin lid, the display device manipulated by a user to access readings produced by collecting and processing data from sensors deployed within the volume of the bin.

11. The product containment system of claim 11, wherein the bin further includes a connector adapted to bridge a data link between one or more telemetric devices and a remote computing appliance.

13. The product containment system of claim 4, wherein the latch clamps are lockable via a key, a user provided lock, a combination, or a wireless code.

14. The product containment system of claim 1, wherein the bin lid contains a pop up bubble feature that pops down when a vacuum pressure of a certain threshold is applied within the bin.

15. A method for aggregating, containing, and preparing product for shipping comprising steps:
(a) position a product containment system bin for loading product, the bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin, at least one valve incorporated into the bin lid or into the at least one bin side wall;
(b) if specified, place one or more product treatment items and or disperse one or more product treatment substances into the bin;
(c) load or otherwise disperse organic product into the bin volume to a level deemed appropriate for shipping or storage;
(d) Position the bin lid over the bin sealing surface and clamp the bin lid down over the gasket and sealing surface of the bin;
(e) if specified, connect a pump by hose and fitting to the valve on the bin and pump air into or out of the bin to a specified pressure;
(f) disconnect and seal the valve once specified pressure is realized; and
(g) arrange bin for shipping or storage.

16. The method of claim 15, wherein in step (b), the one or more product treatment items include one or more oxygen absorbers, and one or more humidity control packets.

17. The method of claim 15, wherein in step (b), the one or more product treatment substances selected from a group consisting of combination of terpenes, mold inhibitors and parasite inhibitors.

18. A method for acquiring data recorded by one or more telemetric devices incorporated by physical placement or original equipment manufacturer into a product containment system having an open bin having a closed end, at least one side wall, and an open end bordered by a substantially horizontal sealing surface and an internal volume defined by the enclosure below the sealing surface, a bin lid configured geometrically to fit over the bin, a gasket disposed between the bin lid and the sealing surface of the bin comprising steps:
(a) connect a remote computing appliance running a software application by data cable or by a wireless data link to a bridge connector hermetically sealed into the bin wall or bin lid;
(b) through the software application, access one or more categories of bin data recorded and stored for access;
(c) upload some or all of the available data onto the remote computing appliance; and,
(d) terminate the connection formed at step (a).

19. The method of claim 18, wherein in step (a), the bridge connector is one of a universal serial bus cable connector or a wireless transceiver node.

20. The method of claim 18, wherein in step (b) the data categories include product and or bin related data, wherein related data is relative humidity, barometric pressure, temperature, product content humidity, mold contaminant level, other contaminant level, presence of parasitic involvement, product potency state, oxygen levels, gas levels, and electronic shipping data such as estimated arrival times, dock wait times, location data, bar code data, and RFID chip data.
